(19) United States
(12) Patent Application Publication
(10) Pub. No.: US 2015/0224822 A1
(43) Pub. Date: Aug. 13, 2015

(54) Wheel Hub

(71) Applicant: Chung-Lin Lai, Taichung City (TW)

(72) Inventor: Chung-Lin Lai, Taichung City (TW)

(21) Appl. No.: 14/613,539

(22) Filed: Feb. 4, 2015

(30) Foreign Application Priority Data
Feb. 12, 2014 (TW) 103202427
Oct. 29, 2014 (TW) 103219124

(51) Int. Cl. B60B 27/02; B60B 1/04

(52) U.S. Cl. CPC B60B 27/023; B60B 1/042; B60B 2900/572

(57) ABSTRACT

A wheel hub includes tubular first and second hub bodies. The first hub body includes a first surrounding wall and a first spoke-mounting segment. The first surrounding wall has a first end portion and a first coupling portion disposed on the first end portion. The first spoke-mounting segment is connected to the first surrounding wall at a position opposite to the first end portion. The second hub body includes a second surrounding wall and a second spoke-mounting segment connected to the second surrounding wall. The second surrounding wall has a second end portion facing the first end portion and a second coupling portion disposed on the second end portion and coupled fixedly to the first coupling portion.

### CROSS-REFERENCE TO RELATED APPLICATION

This application claims priorities of Taiwanese Application No. 103202427, filed on Feb. 12, 2014, and Taiwanese Application No. 103219124, filed on Oct. 29, 2014.

### FIELD

The disclosure relates to a wheel hub, and more particularly to a wheel hub adapted for a bicycle.

### BACKGROUND

A conventional wheel hub, as disclosed in Taiwanese Invention Patent No. I417220 and Taiwanese Utility Model Patent No. M463202, has a tubular unitary hub body and two spoke-mounting portions that are respectively connected to two opposite sides of the unitary hub body. Each of the spoke-mounting portions has a plurality of holes or grooves for installation of spokes.

Although the conventional wheel hub is popularly used, the opposite sides of the unitary hub body have to be respectively processed for formation of the holes or grooves of the spoke-mounting portions. As a result, the fabrication process of the conventional wheel hub is relatively complicated, production capacity is lower, and manufacturing cost is higher.

Further, the conventional bicolor wheel hub is made by forming a first dye coating on the hub body through a first anodizing treatment, removing the first dye coating coated on a predetermined portion of the hub body, and then forming a second dye coating, which has a color different from that of the first dye coating, through a second anodizing treatment. However, it can be difficult to form a multi-color wheel hub having more than two colors with the anodizing treatment.

### SUMMARY

Therefore, an object of the disclosure is to provide a wheel hub that can alleviate at least one of the drawbacks of the prior arts.

According to the disclosure, the wheel hub includes a tubular first hub body and a tubular second hub body.

The tubular first hub body includes a first surrounding wall and a first spoke-mounting segment. The first surrounding wall surrounds an axis, and has a first end portion and a first coupling portion disposed on the first end portion. The first spoke-mounting segment is connected to the first surrounding wall at a position opposite to the first end portion along the axis.

The tubular second hub body includes a second surrounding wall and a second spoke-mounting segment. The second surrounding wall surrounds the axis, and has a second end portion facing the first end portion and a second coupling portion disposed on the second end portion and coupled fixedly to the first coupling portion. The second spoke-mounting segment is connected to the second surrounding wall and is spaced apart from the first spoke-mounting portion.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating a first embodiment of a wheel hub according to the disclosure;

FIG. 2 is a fragmentary sectional view of the first embodiment;

FIG. 3 is a sectional view of the first embodiment taken along line III-III in FIG. 2;

FIG. 4 is an exploded perspective view illustrating a second embodiment of a wheel hub according to the disclosure;

FIG. 5 is a fragmentary sectional view of the second embodiment;

FIG. 6 is a sectional view of the second embodiment taken along line VI-VI in FIG. 5;

FIG. 7 is an exploded perspective view illustrating a third embodiment of a wheel hub according to the disclosure;

FIG. 8 is a fragmentary sectional view of the third embodiment;

FIG. 9 is an exploded perspective view illustrating a fourth embodiment of a wheel hub according to the disclosure; and

FIG. 10 is a sectional view of the fourth embodiment.

### DETAILED DESCRIPTION

Before the disclosure is described in greater detail, it should be noted that like elements are denoted by the same reference numerals throughout the disclosure.

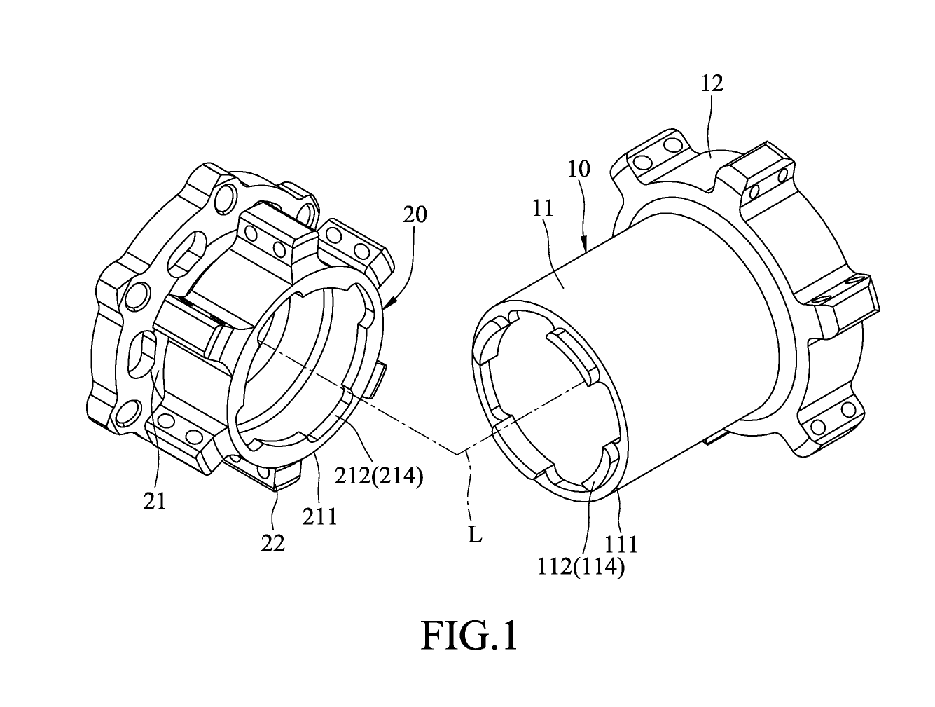

Referring to FIGS. 1 to 3, the first embodiment of a wheel hub according to the disclosure is illustrated. The wheel hub includes a tubular first hub body 10 and a tubular second hub body 20.

The first hub body 10 includes a first surrounding wall 11 that surrounds an axis (L), and a first spoke-mounting segment 12. The first surrounding wall 11 has a first end portion 111 and a first coupling portion 112 disposed on the first end portion 111. The first spoke-mounting segment 12 is connected to the first surrounding wall 11 at a position opposite to the first end portion 111 along the axis (L).

The second hub body 20 includes a second surrounding wall 21 that surrounds the axis (L), and a second spoke-mounting segment 22. The second surrounding wall 21 has a second end portion 211 that faces the first end portion 111 and a second coupling portion 212 that is disposed on the second end portion 211 and is coupled fixedly to the first coupling portion 112. The second spoke-mounting segment 22 is connected to the second surrounding wall 21 and is spaced apart from the first spoke-mounting portion 12.

In this embodiment, the first coupling portion 112 of the first surrounding wall 11 has a plurality of angularly spaced-apart engaging protrusions 114 around the axis (L). The second coupling portion 212 of the second surrounding wall 21 has a plurality of angularly spaced-apart engaging grooves 214 that are engaged respectively with the engaging protrusions 114, for example, in a tight-fit manner. For another example, an adhesive layer 30 is disposed between the engaging protrusions 114 and the engaging grooves 214 so that the first coupling portion 112 is adhered to the second coupling portion 212.

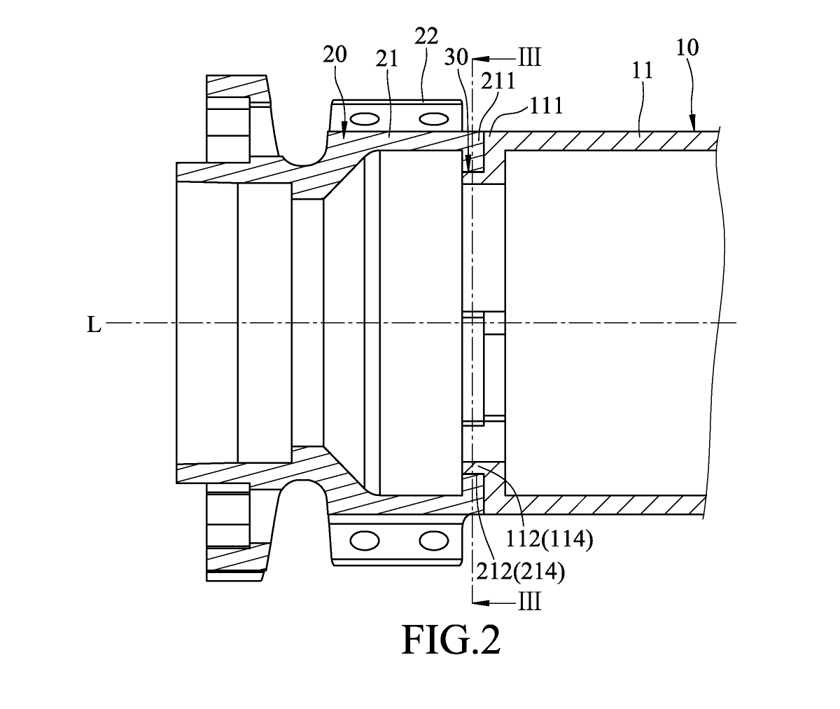

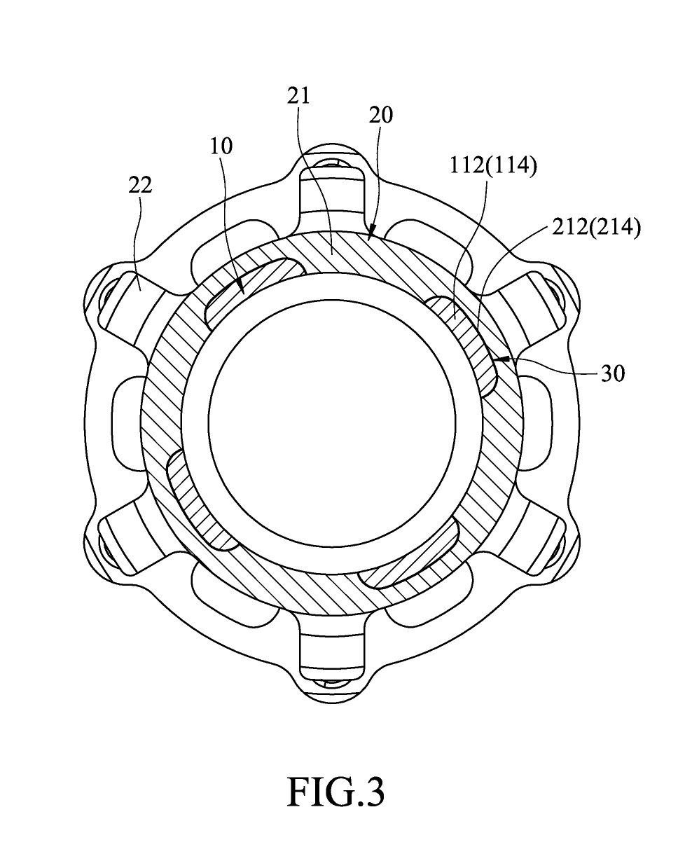

As shown in FIGS. 2 and 3, when the wheel hub is assembled, since the engaging grooves 214 of the second coupling portion 212 are respectively engaged with the engaging protrusions 114 of the first coupling portion 112 in the tight-fit manner and are further adhered to each other with the adhesive layer 30, the first hub body 10 and the second hub body 20 are secured fixedly to each other to have an improved structural strength and to prevent relative rotation between the first hub body 10 and the second hub body 20.

During manufacturing of the wheel hub, since the first hub body 10 and the second hub body 20 may be independently produced, respective formation of the holes or grooves in the first spoke-mounting segment 12 and the second spoke-mounting segment 21 may be independently carried out, thereby simplifying the manufacturing process of the wheel hub and reducing costs and time associated therewith. Accordingly, product yield and production capacity are increased.

In addition, since the first hub body 10 and the second hub body 20 maybe independently produced, they may each be coated with different dye coatings with the anodizing treatment so that the wheel hub thus formed may have a multi-color and appealing appearance. For example, the first hub body 10 and the second hub body 20 may each be coated with two different-colored dye coatings relatively easily, then be assembled to form a four-color wheel hub.

Alternatively, the angularly spaced-apart engaging grooves 214 may be formed in the first coupling portion 112 of the first surrounding wall 11 instead of being formed on the second coupling portion 212 of the second surrounding wall 21 and the angularly spaced-apart engaging protrusions 114 may be formed on the second coupling portion 212 instead of being formed on the first coupling portion 112.

In other embodiments, instead of forming the engaging protrusions 114 or the engaging grooves 214, one of the first coupling portion 112 of the first hub body 11 and the second coupling portion 212 of the second hub body 20 may be entirely configured as a male coupler (not shown). The other one of the first coupling portion 112 of the first hub body 11 and the second coupling portion 212 of the second hub body 20 may be entirely configured as a female coupler (not shown). Both the male and female couplers may have a polygonal cross section. By virtue of the abovementioned configuration, i.e., engagement of the first coupling portion 112 of the first hub body 11 and the second coupling portion 212 of the second hub body 20, the first hub body 11 and the second hub body 20 is likewise cable of being fixedly coupled to each other and the relative rotation therebetween is avoided.

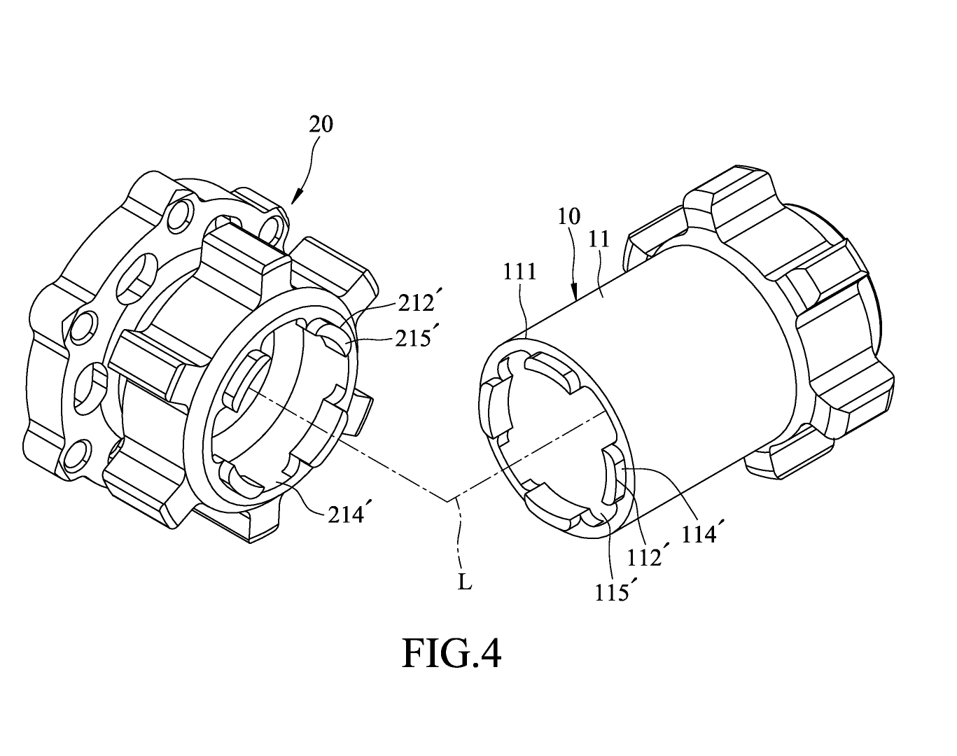

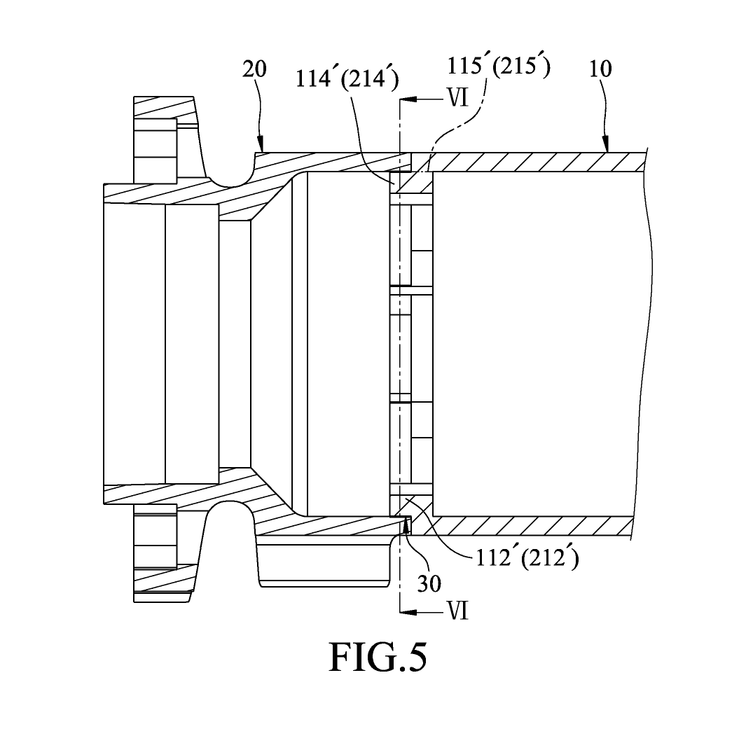

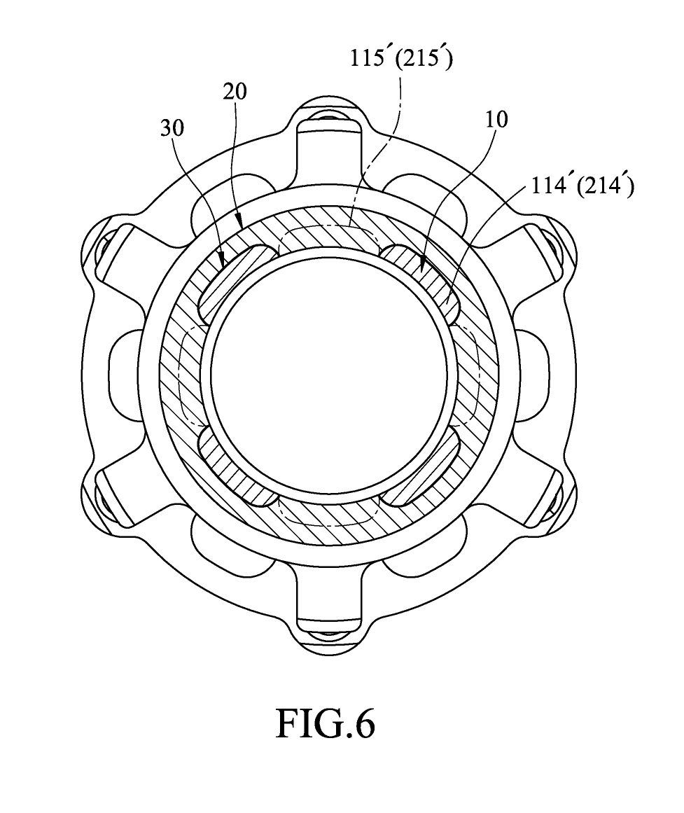

FIGS. 4 to 6 illustrate the second embodiment of a wheel hub according to the disclosure, which has a configuration similar to that of the first embodiment. However, in the second embodiment, the first coupling portion 112′ of the first surrounding wall 11 has a plurality of angularly spaced-apart first engaging protrusions 114′ and a plurality of angularly spaced-apart first engaging grooves 115′. Each of the first engaging grooves 115′ is disposed between two adjacent ones of the first engaging protrusions 114′. The second coupling portion 212′ of the second surrounding wall 21 has a plurality of angularly spaced-apart second engaging grooves 214′ that are engaged respectively with the first engaging protrusions 114′, and a plurality of angularly spaced-apart second engaging protrusions 215′ that engage respectively the first engaging grooves 115′. Therefore, the first coupling port ion 112′ and the second coupling portion 212′ are coupled to each other in the tight-fit manner to have improved structural strength.

As an another example, the adhesive layers 30 may be respectively disposed among the first engaging protrusions 114′ and the second engaging grooves 214′ and among the second engaging protrusions 215′ and the first engaging grooves 115′, with the first coupling portion 112 being adhered to the second coupling portion 212.

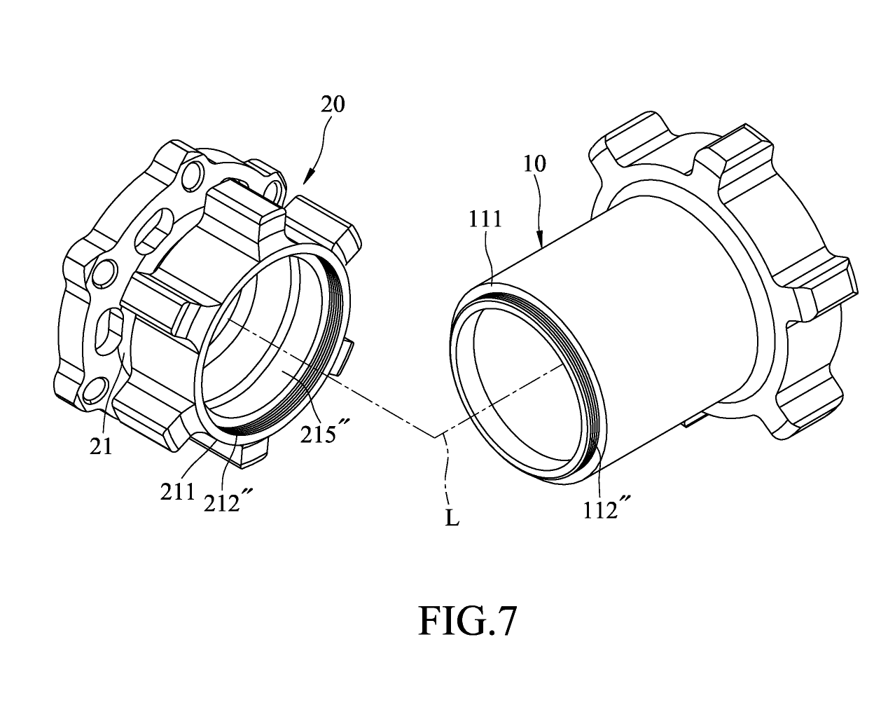

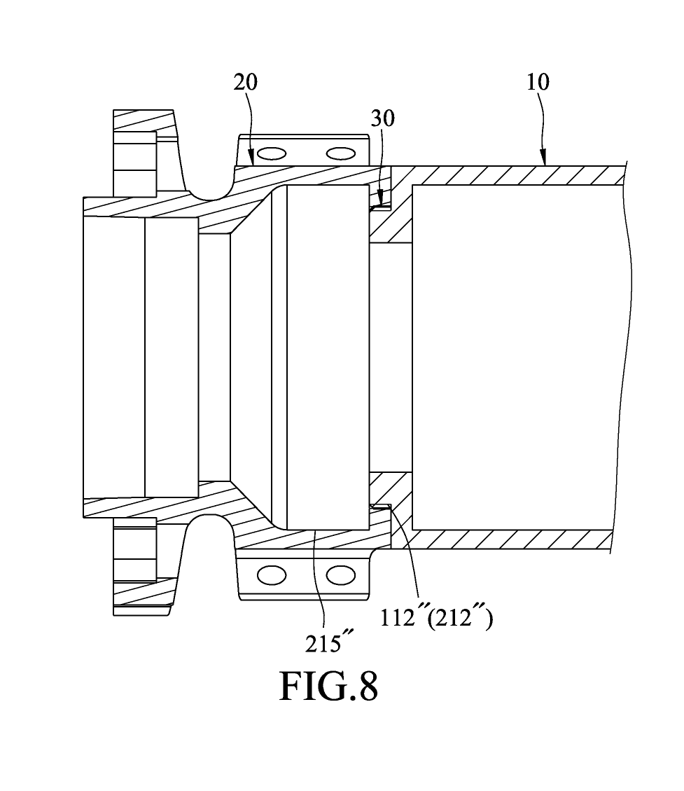

FIGS. 7 and 8 illustrate the third embodiment of a wheel hub according to the disclosure, which is a modification of the abovementioned embodiments. In this embodiment, the first coupling portion 112″ of the first surrounding wall 11 is an external thread. The second end portion 211 of the second surrounding wall 21 further has an inner surrounding surface 215″. The second coupling portion 212″ is an internal thread that is formed on the inner surrounding surface 215″ and that is threadedly engaged with the first coupling portion 112″.

Alternatively, the first surrounding wall 11 of the first hub body 10 may have an inner surrounding surface (not shown) formed with the first coupling portion 112″, which is the inner thread (not shown) in this configuration of the embodiment. The second coupling portion 212″ of the first surrounding wall 11 is the external thread (not shown) herein.

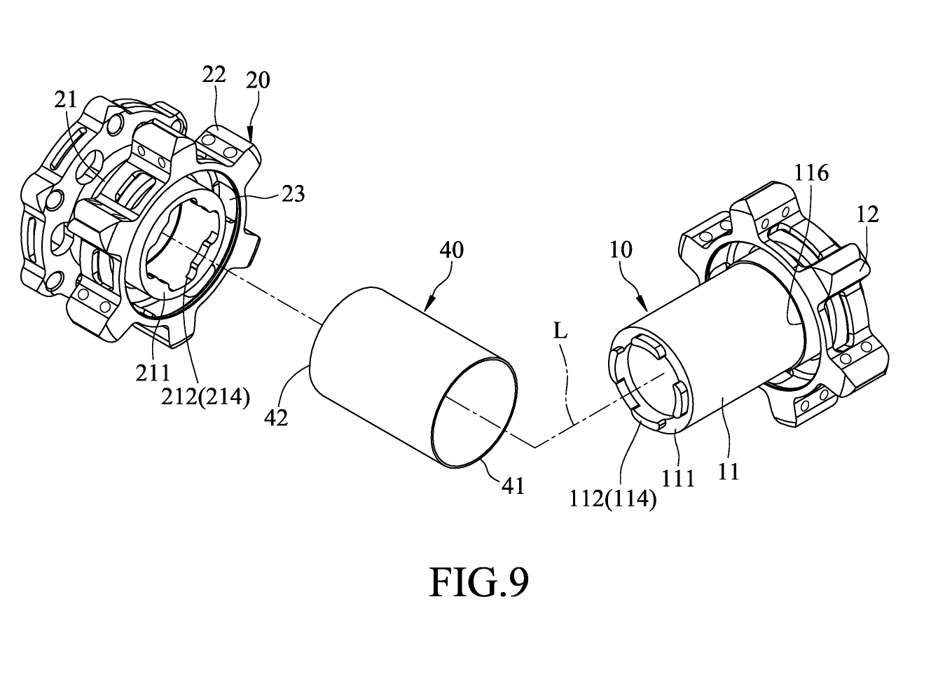

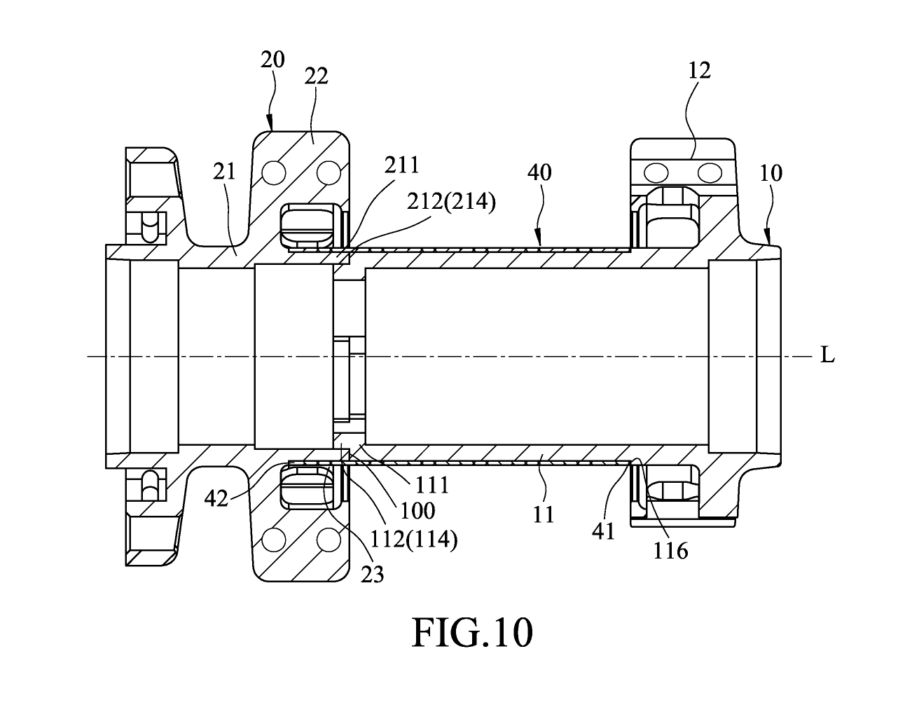

FIGS. 9 and 10 illustrate the fourth embodiment of a wheel hub according to the disclosure, which has a configuration similar to that of the first embodiment. Particularly, in this embodiment, the wheel hub further includes a sleeve 40 that extends along the axis (L) and that is sleeved on and adhered to the first surrounding wall 11 of the first hub body 10 and the second surrounding wall 21 of the second hub body 20. The sleeve 40 has first and second end sections 41, 42 that are opposite to each other along the axis (L) and that are disposed at opposite sides of a junction 100 between the first and second hub bodies 10, 20. As a non-limiting example, the sleeve 40 may be made of a carbon fiber composite material.

In this embodiment, the first surrounding wall 11 of the first hub body 10 further has a stopper portion 116 that is disposed in proximity to the first spoke-mounting portion 12. As such, the first end section 41 of the sleeve 40 abuts against the stopper portion 116.

The second hub body 20 further has an annular groove 23 that is formed in an intersection between the second spoke-mounting portion 22 and the second surrounding wall 21 and that surrounds the axis (L). The second sleeve section 42 of the sleeve 40 extends into the annular groove 23.

In this embodiment, the sleeve 40 serves to enhance the structural strength of the wheel hub, and an outer surface of the sleeve 40 may be adapted to be provided with a trade mark, a brand name, a logotype or any desired information or patterns thereon.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A wheel hub comprising:
a tubular first hub body including
a first surrounding wall that surrounds an axis, and that has a first end portion and a first coupling portion disposed on said first end portion, and
a first spoke-mounting segment that is connected to said first surrounding wall at a position opposite to said first end portion along the axis; and
a tubular second hub body including
a second surrounding wall that surrounds the axis, and that has a second end portion facing said first end portion and a second coupling portion disposed on said second end portion and coupled fixedly to said first coupling portion, and
a second spoke-mounting segment that is connected to said second surrounding wall and that is spaced apart from said first spoke-mounting portion.

2. The wheel hub as claimed in claim 1, wherein:
said first coupling portion of said first surrounding wall has a plurality of angularly spaced-apart engaging protrusions; and
said second coupling portion of said second surrounding wall has a plurality of angularly spaced-apart engaging grooves that are engaged respectively with said engaging protrusions.

3. The wheel hub as claimed in claim 1, wherein:
said first coupling portion of said first surrounding wall has a plurality of angularly spaced-apart engaging grooves; and
said second coupling portion of said second surrounding wall has a plurality of angularly spaced-apart engaging protrusions that engage respectively said engaging grooves.

4. The wheel hub as claimed in claim 1, wherein:
said first coupling portion of said first surrounding wall has a plurality of angularly spaced-apart first engaging protrusions and a plurality of angularly spaced-apart first engaging grooves; and
said second coupling portion of said second surrounding wall has a plurality of angularly spaced-apart second engaging grooves that are engaged respectively with said first engaging protrusions, and a plurality of angularly spaced-apart second engaging protrusions that engage respectively said first engaging grooves.

5. The wheel hub as claimed in claim 1, wherein:
said first coupling portion of said first surrounding wall is an external thread; and
said second end portion of said second surrounding wall further has an inner surrounding surface, said second coupling portion being an internal thread that is formed on said inner surrounding surface and that is threadedly engaged with said first coupling portion.

6. The wheel hub as claimed in claim 1, wherein said First coupling portion is adhered to said second coupling portion.

7. The wheel hub as claimed in claim 1, further comprising a sleeve that extends along the axis and that is sleeved on said first surrounding wall of said first hub body and said second surrounding wall of said second hub body, said sleeve having first and second end sections that are opposite to each other along the axis and that are disposed at opposite sides of a junction between said first and second hub bodies.

8. The wheel hub as claimed in claim 7, wherein said second hub body further has an annular groove that is formed in an intersection between said second spoke-mounting portion and said second surrounding wall and that surrounds the axis, said second sleeve section of said sleeve extending into said annular groove.

9. The wheel hub as claimed in claim 8, wherein said first surrounding wall of said first hub body further has a stopper portion that is disposed in proximity to said first spoke-mounting portion, said first end section of said sleeve abutting against said stopper portion.

10. The wheel hub as claimed in claim 1, further comprising a sleeve that is made of a carbon fiber composite material, and that is sleeved on and adhered to said first surrounding wall of said first hub body and said second surrounding wall of said second hub body.
